(19) United States
(12) Patent Application Publication
(10) Pub. No.: US 2025/0385982 A1
(43) Pub. Date: Dec. 18, 2025

(54) METHOD FOR TRANSMITTING AND RECEIVING ANALOG IMAGE SIGNAL AND APPARATUS PERFORMING SAID METHOD

(71) Applicant: Nextchip Co., Ltd., Seoul (KR)

(72) Inventor: E Woo CHON, Seoul (KR)

(73) Assignee: Nextchip Co., Ltd., Seoul, KG (KR)

(21) Appl. No.: 18/878,725

(22) PCT Filed: Jun. 8, 2023
(86) PCT No.: PCT/KR2023/007796

§ 371 Date: Dec. 24, 2024

(30) Foreign Application Priority Data
Nov. 11, 2022 (KR) 10-2022-0150825

(51) Int. Cl. H04N 5/38; H04N 5/067; H04N 5/08; H04N 5/44; H04N 7/10

(52) U.S. Cl. CPC H04N 5/38; H04N 5/0675; H04N 5/08; H04N 5/44; H04N 7/10

(57) ABSTRACT

The present invention may comprise: in order to receive an analog image signal, generating a camera initialization signal including operation period information of a camera; transmitting the camera initialization signal to a plurality of analog image signal transmission apparatuses; determining whether or not each of the plurality of analog image signal transmission apparatuses is ready to transmit the analog image signal; if determining that each of the plurality of analog image signal transmission apparatuses is ready to transmit the analog image signal, simultaneously transmitting a transmission command signal to the plurality of analog image signal transmission apparatuses; and receiving a plurality of analog image signals from the plurality of analog image signal transmission apparatuses.

### TECHNICAL FIELD

The following embodiments relate to technology for transmitting and receiving an analog image signal, and more particularly, to technology for transmitting and receiving a plurality of analog image signals.

### BACKGROUND ART

In a system for transmitting and receiving an analog image signal, a control signal for controlling the transmission of an analog image signal is transmitted to an analog image signal transmission apparatus. There is a method of using a separate control cable to transmit a command and a method of using a cable to transmit an image. There may be difficulties in the security of a system when a separate control cable is used.

Korean Patent Application Publication No. 10-2011-0030872 (Mar. 24, 2011) discloses a surveillance camera control system. The disclosed invention relates to a surveillance camera control system including a transmitter that transmits a pan/tilt control signal of a surveillance camera and outputs an image transmitted from the surveillance camera, a receiver that controls the surveillance camera by receiving a control signal input to an address from the transmitter, and the surveillance camera. The receiver includes an address inputter that may input its address with decimal data, a protocol setter that may select a certain protocol by storing protocol information for each product to support multi-protocols, and a display that may display an operating state of each part of the receiver.

### DISCLOSURE OF THE INVENTION

### Technical Solutions

According to an embodiment, an analog image signal reception method performed by an analog image signal reception apparatus includes generating a camera initialization signal including camera operation cycle information, transmitting the camera initialization signal to a plurality of analog image signal transmission apparatuses, determining whether each of the plurality of analog image signal transmission apparatuses is ready to transmit an analog image signal, simultaneously transmitting a transmission command signal to the plurality of analog image signal transmission apparatuses when it is determined that each of the plurality of analog image signal transmission apparatuses is ready to transmit an analog image signal, and receiving a plurality of analog image signals from the plurality of analog image signal transmission apparatuses.

The plurality of analog image signals may have the same image resolution.

The camera initialization signal may be added to a horizontal blank area, a horizontal sync area, a front burst interval area, a burst area, or a back burst interval area of an analog image signal.

The camera initialization signal may be added to a preset area of a line of a vertical blank period of an analog image signal.

The analog image signal reception method may further include detecting, from the plurality of analog image signals, first synchronization information of a first analog image signal and second synchronization information of a second analog image signal, determining a timing difference between the plurality of analog image signals, based on the first synchronization information and the second synchronization information, and transmitting, among the plurality of analog image signal transmission apparatuses, information about the timing difference to a target analog image signal transmission apparatus, based on the timing difference.

The analog image signal reception method may further include receiving a target analog image signal with the timing difference corrected from the target analog image signal transmission apparatus.

The target analog image signal with the timing difference corrected may include a plurality of horizontal lines including a target horizontal line in which a length of the target horizontal line is corrected to correspond to the timing difference.

The receiving of the target analog image signal with the timing difference corrected from the target analog image signal transmission apparatus may include generating a synchronization mask signal and receiving the target analog image signal using the synchronization mask signal.

The synchronization mask signal may have a high signal in a target area of the synchronization mask signal corresponding to a preset area of the target analog image signal.

The preset area of the target analog image signal may include a horizontal blank area, a horizontal sync area, a front burst interval area, a burst area, or a back burst interval area.

According to an embodiment, an analog image signal reception apparatus for performing an analog image signal reception method includes a memory configured to store a program for receiving an analog image signal and a processor configured to perform the program, in which the program is configured to perform generating a camera initialization signal including camera operation cycle information, transmitting the camera initialization signal to a plurality of analog image signal transmission apparatuses, determining whether each of the plurality of analog image signal transmission apparatuses is ready to transmit an analog image signal, simultaneously transmitting a transmission command signal to the plurality of analog image signal transmission apparatuses when it is determined that each of the plurality of analog image signal transmission apparatuses is ready to transmit an analog image signal, and receiving a plurality of analog image signals from the plurality of analog image signal transmission apparatuses.

According to an embodiment, an analog image signal transmission method performed by an analog image signal transmission apparatus includes transmitting a first analog image signal to an analog image signal reception apparatus, receiving information about a timing difference from the analog image signal reception apparatus, generating a second analog image signal in which a length of an analog image signal is adjusted, based on the information about the timing difference, and transmitting the second analog image signal to the analog image signal reception apparatus.

The second analog image signal may include a plurality of horizontal lines including a target horizontal line in which a length of the target horizontal line is corrected to correspond to the information about the timing difference.

The generating of the second analog image signal in which the length of the analog image signal is adjusted, based on the information about the timing difference, may include generating the second analog image signal by adjusting lengths of a horizontal blank area, a horizontal sync area, a front burst interval area, a burst area, or a back burst interval area of the target horizontal line, based on the information about the timing difference.

The analog image signal transmission apparatus may be configured to transmit, to the analog image signal reception apparatus, the first analog image signal and the second analog image signal using a coaxial cable.

According to an embodiment, an analog image signal transmission apparatus for performing an analog image signal transmission method includes a memory configured to store a program for transmitting an analog image signal and a processor configured to perform the program, in which the program is configured to perform transmitting a first analog image signal to an analog image signal reception apparatus, receiving information about a timing difference from the analog image signal reception apparatus, generating a second analog image signal in which a length of an analog image signal is adjusted, based on the information about the timing difference, and transmitting the second analog image signal to the analog image signal reception apparatus.

### BRIEF DESCRIPTION OF DRAWINGS

FIG. 1 is a configuration of an analog image signal transmission/reception system, according to an embodiment.

FIG. 2 is a configuration of an analog image signal reception apparatus, according to an embodiment.

FIG. 3 is a flowchart of an analog image signal reception method, according to an embodiment.

FIG. 4 illustrates a vertical timing of an analog image signal, according to an embodiment.

FIG. 5 illustrates an active line of an analog image signal, according to an embodiment.

FIG. 6 is a flowchart of a method of receiving a target analog image signal in which the length of an analog image signal is corrected, based on a timing difference between a plurality of analog image signals, according to an embodiment.

FIG. 7 illustrates a timing difference between a plurality of analog image signals, according to an embodiment.

FIG. 8 illustrates target analog image signals in which the length of an analog image signal is corrected, according to an embodiment.

FIG. 9 is a flowchart of a method of receiving a target analog image signal using a synchronization mask signal, according to an embodiment.

FIG. 10 illustrates a synchronization mask signal according to an embodiment.

FIG. 11 is a flowchart of a method of receiving a target analog image signal in which the length of an analog image signal is corrected, based on a timing difference between a plurality of analog image signals, according to an embodiment.

FIG. 12 is a configuration of an analog image signal transmission apparatus, according to an embodiment.

FIG. 13 is a flowchart of an analog image signal transmission method, according to an embodiment.

### BEST MODE FOR CARRYING OUT THE INVENTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions on the embodiments may be applicable to the following embodiments and thus, duplicated descriptions will be omitted for conciseness.

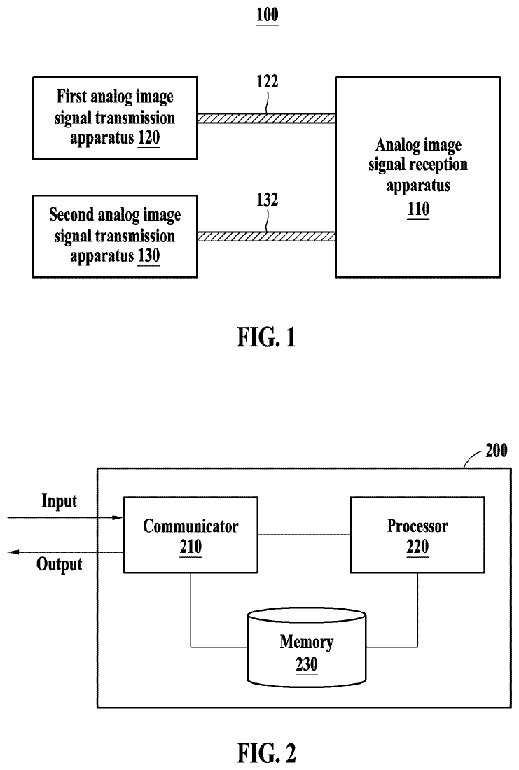

FIG. 1 is a configuration of an analog image signal transmission/reception system, according to an embodiment.

According to an embodiment, an analog image signal transmission/reception system 100 may include an analog image signal reception apparatus 110 and a plurality of analog image signal transmission apparatuses. The plurality of analog image signal transmission apparatuses may include a first analog image signal transmission apparatus 120 and a second analog image signal transmission apparatus 130. For example, the first analog image signal transmission apparatus 120 may be connected to the analog image signal reception apparatus 110 through a first coaxial cable 122, and the second analog image signal transmission apparatus 130 may be connected to the analog image signal reception apparatus 110 through a second coaxial cable 132. For example, the connection between the analog image signal reception apparatus 110 and the first analog image signal transmission apparatus 120 may be referred to as a first channel, and the connection between the analog image signal reception apparatus 110 and the second analog image signal transmission apparatus 130 may be referred to as a second channel.

The analog image signal reception apparatus 110 and each of the plurality of analog image signal transmission apparatuses may transmit commands to other apparatuses by exchanging protocols. For example, the protocols may be included in an analog image signal and transmitted to other apparatuses.

According to an embodiment, the analog image signal reception apparatus 110 may transmit, to an analog image signal transmission apparatus, a protocol corresponding to a command for controlling an operation of a sensor (e.g., a camera) of an analog image signal transmission apparatus (e.g., the first analog image signal transmission apparatus 120) by loading the protocol on the analog image signal. The analog image signal transmission apparatus may generate a target analog image signal with the command reflected and may transmit the generated target analog image signal to the analog image signal reception apparatus 110.

According to an embodiment, the analog image signal reception apparatus 110 may receive a plurality of analog image signals generated by the plurality of analog image signal transmission apparatuses for the same scene. Since the plurality of analog image signals is images captured by the camera from different viewpoints for the same scene, when the plurality of analog image signals is synchronized, a user who is simultaneously observing the plurality of analog image signals may view (or observe) natural images.

Hereinafter, a method of transmitting and receiving a plurality of synchronized analog image signals is described in detail with reference to FIGS. 2 to 13.

FIG. 2 is a configuration of an analog image signal reception apparatus, according to an embodiment.

According to an embodiment, an analog image signal reception apparatus 200 may include a communicator 210, a processor 220, and a memory 230. For example, the analog image signal reception apparatus 200 may be the analog image signal reception apparatus 110 described above with reference to FIG. 1.

The communicator 210 may be connected to the processor 220 and the memory 230 to transmit and receive data to and from the processor 220 and the memory 230. The communicator 210 may be connected to another external device and transmit and receive data to and from the external device. Hereinafter, transmitting and receiving “A” may refer to transmitting and receiving “information or data indicating A.”

The communicator 210 may be implemented as circuitry in the analog image signal reception apparatus 200. For example, the communicator 210 may include an internal bus and an external bus. In another example, the communicator 210 may be an element that connects the analog image signal reception apparatus 200 to the external device. The communicator 210 may be an interface. The communicator 210 may receive data from the external device and transmit the data to the processor 220 and the memory 230.

The processor 220 may process the data received by the communicator 210 and data stored in the memory 230. The “processor” may be a data processing device implemented by hardware including a circuit having a physical structure to perform desired operations. For example, the desired operations may include code or instructions in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 220 may execute computer-readable code (e.g., software) stored in a memory (e.g., the memory 230) and instructions triggered by the processor 220.

The memory 230 may store data received by the communicator 210 and data processed by the processor 220. For example, the memory 230 may store a program (or an application or software). The stored program may be a set of syntaxes that are coded to receive an analog image signal and executable by the processor 220.

According to an aspect, the memory 230 may include at least one volatile memory, non-volatile memory, random-access memory (RAM), flash memory, a hard disk drive, and an optical disc drive.

The memory 230 may store an instruction set (e.g., software) for operating the analog image signal reception apparatus 200. The instruction set for operating the analog image signal reception apparatus 200 may be executed by the processor 220.

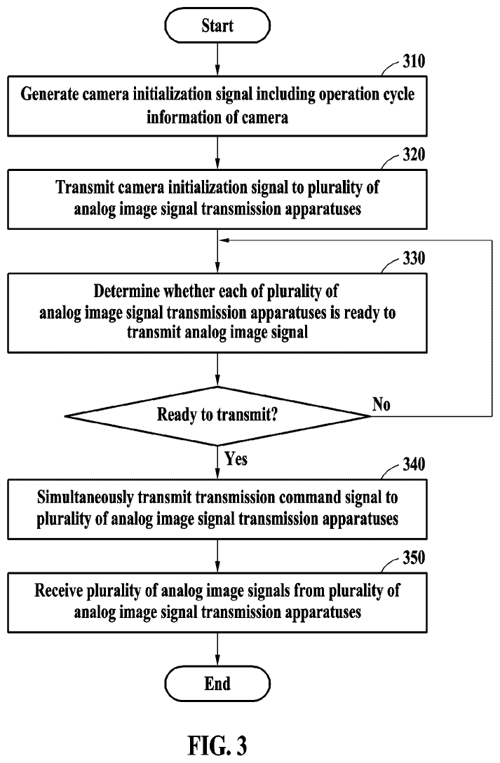

The communicator 210, the processor 220, and the memory 230 are described in detail below with reference to FIGS. 3 to 11.

FIG. 3 is a flowchart of an analog image signal reception method, according to an embodiment.

Operations 310 to 350 below are performed by the analog image signal reception apparatus 200 described above with reference to FIG. 2.

In operation 310, the analog image signal reception apparatus 200 may generate a camera initialization signal including operation cycle information of a camera. The operation cycle information may be information about frame synchronization (Fsync). For example, the operation cycle information may vary depending on the resolution of an image to be generated by a camera.

In operation 320, the analog image signal reception apparatus 200 may transmit the camera initialization signal to a plurality of analog image signal transmission apparatuses. For example, the analog image signal reception apparatus 200 may transmit, to a first analog image signal transmission apparatus, the camera initialization signal by displaying information corresponding to the camera initialization signal in a preset area of an analog image signal shared with the first analog image signal transmission apparatus (e.g., the first analog image signal transmission apparatus 120 of FIG. 1) of the plurality of analog image signal transmission apparatuses through a first cable. For example, the camera initialization signal may be added to a horizontal blank area, a horizontal sync area, a front burst interval area, a burst area, or a back burst interval area of the analog image signal. For example, the camera initialization signal may be added to a preset area of a line of a vertical blank period of the analog image signal.

In operation 330, the analog image signal reception apparatus 200 may determine whether each of the plurality of analog image signal transmission apparatuses is ready to transmit the analog image signal.

According to an embodiment, the analog image signal reception apparatus 200 may determine that an analog image signal transmission apparatus is ready to transmit the analog image signal when information about the completion of preparation is received from the analog image signal transmission apparatus. For example, the analog image signal reception apparatus 200 may transmit inquiry information about the completion of preparation to each of the plurality of analog image signal transmission apparatuses and may receive the information about the completion of preparation as a reply to the inquiry information. For example, the inquiry information may be added to a partial area of an analog image signal preset for the analog image signal reception apparatus 200. For example, the reply information may be added to another partial area of an analog image signal preset for the analog image signal transmission apparatus.

In operation 340, the analog image signal reception apparatus 200 may simultaneously transmit a transmission command signal to the plurality of analog image signal transmission apparatuses when it is determined that the plurality of analog image signal transmission apparatuses is ready to transmit the analog image signal.

In operation 350, the analog image signal reception apparatus 200 may receive a plurality of analog image signals from the plurality of analog image signal transmission apparatuses. For example, the plurality of analog image signals may have the same image resolution.

According to an embodiment, since the operation cycles of the plurality of analog image signals are all the same and the transmission start time points of the plurality of analog image signals are all the same, the plurality of analog image signals received by the analog image signal reception apparatus 200 may be synchronized.

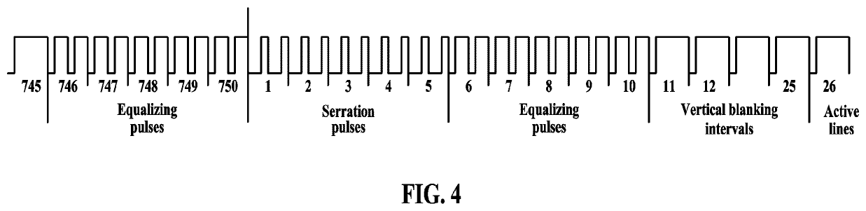

FIG. 4 illustrates a vertical timing of an analog image signal, according to an embodiment.

According to an embodiment, FIG. 4 illustrates lines in a vertical direction, which are 750 lines. The lines may be lines from an upper end to a lower end constructing a frame of an image. That is, line 1 may be the uppermost line of the frame.

For example, lines 1 to 5 may be serration pulses. The serration pulses may be vertical synchronization pulses.

For example, lines 6 to 10 may be post-equalizing pulses. The equalizing pulses may be pulses used to accurately perform interlaced scanning. Lines 746 to 750 may be pre-equalizing pulses.

For example, lines 11 to 25 may be vertical blanking intervals (VBIs).

For example, lines 26 to 745 may be active lines. The active lines may include actual image signals.

Although FIG. 4 illustrates a timing specification in which the number of vertical lines is 750, the description of FIG. 4 may be similarly modified and applied to a timing specification in which the number of vertical lines is 1,125 and a timing specification in which the number of vertical lines is 1,250.

For example, when the number of vertical lines is 1,125, lines 1 to 5 may be serration pulses, lines 6 to 10 may be post-equalizing pulses, lines 11 to 40 may be VBIs, lines 41 to 1120 may be active lines, and lines 1121 to 1125 may be pre-equalizing pulses.

For example, when the number of vertical lines is 1,250, lines 1 to 5 may be serration pulses, lines 6 to 10 may be post-equalizing pulses, lines 11 to 165 may be VBIs, lines 166 to 1245 may be active lines, and lines 1246 to 1250 may be pre-equalizing pulses.

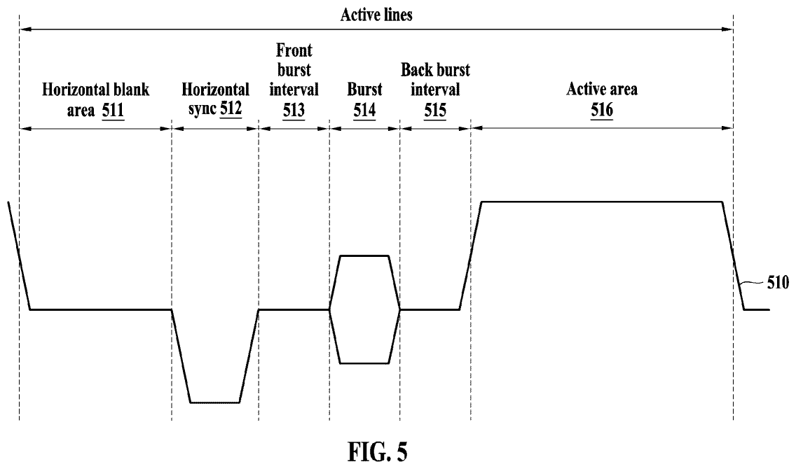

FIG. 5 illustrates an active line of an analog image signal, according to an embodiment.

According to an embodiment, a horizontal line 510 (a horizontal line including an active area) other than a horizontal line constructing a vertical blank line may include a horizontal blank area 511, a horizontal sync 512, a front burst interval 513, a burst 514, a back burst interval 515, and an active area 516.

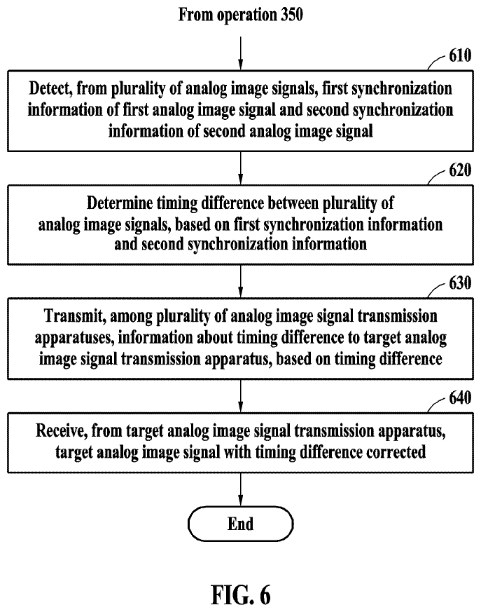

FIG. 6 is a flowchart of a method of receiving a target analog image signal in which the length of an analog image signal is corrected, based on a timing difference between a plurality of analog image signals, according to an embodiment.

According to operations 310 to 350 described above with reference to FIG. 3, even when the analog image signal reception apparatus 200 receives a plurality of synchronized analog image signals, the plurality of analog image signals may become unsynchronized as time elapses. For example, the plurality of analog image signals may become unsynchronized due to the difference in the physical lengths between channels. For example, the plurality of analog image signals may become unsynchronized due to the slight difference in system clocks used by each of a plurality of analog image signal transmission apparatuses. Operations 610 to 640 below may be performed to resynchronize the plurality of analog image signals.

According to an embodiment, operations 610 to 640 below may be performed after operation 350 described above with reference to FIG. 3 is performed.

In operation 610, the analog image signal reception apparatus 200 may detect, from the plurality of analog image signals, first synchronization information of a first analog image signal and second synchronization information of a second analog image signal. For example, a horizontal line of an analog image signal from which synchronization information is detected may be determined in advance. For example, a horizontal sync of a first active line of a plurality of horizontal lines constituting an analog image signal may be detected as synchronization information.

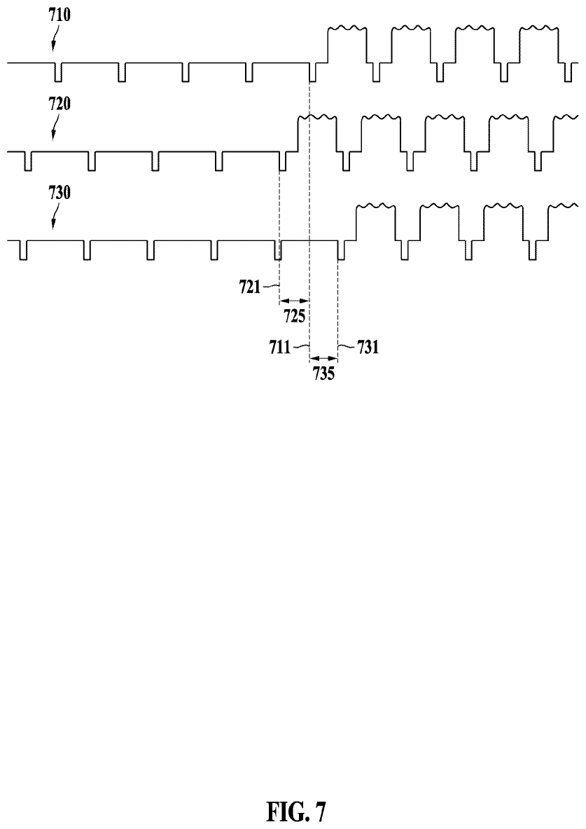

In operation 620, the analog image signal reception apparatus 200 may determine a timing difference between the plurality of analog image signals, based on the first synchronization information and the second synchronization information. For example, the time point of a first horizontal sync corresponding to the first synchronization information may be a reference time point, and the difference between the time point of a second horizontal sync corresponding to the second synchronization information and the reference time point may be determined to be the timing difference. The timing difference between the plurality of analog image signals is described in detail below with reference to FIG. 7.

According to an embodiment, the analog image signal reception apparatus 200 may determine whether the determined timing difference is greater than or equal to a preset threshold value. For example, when the determined timing difference is less than the preset threshold value, the plurality of analog image signals may be determined to be in a synchronized state. For example, operation 630 may be performed only when the determined timing difference is greater than or equal to the preset threshold value.

In operation 630, the analog image signal reception apparatus 200 may transmit, among the plurality of analog image signal transmission apparatuses, information about the timing difference to a target analog image signal transmission apparatus, based on the timing difference. For example, when a first analog image transmission apparatus is a reference apparatus, other analog image signal transmission apparatuses, except for the first analog image transmission apparatus, may be determined to be the target analog image signal transmission apparatuses. For example, when the timing difference of −a may be determined for the second analog image signal and the timing difference of +b may be determined for a third analog image signal, information about the timing difference of −a may be transmitted to a second analog image signal transmission apparatus, and information about the timing difference of +b may be transmitted to a third analog image signal transmission apparatus.

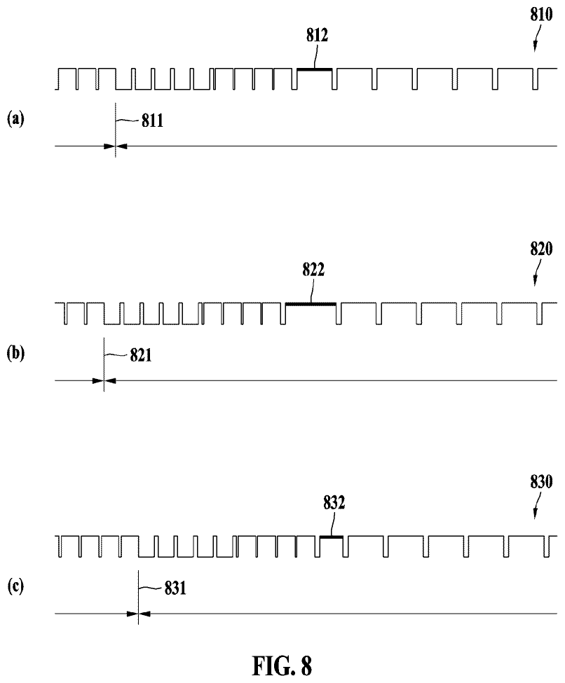

According to an embodiment, the target analog image signal transmission apparatus may generate a target analog image signal with the timing difference corrected, based on the received timing difference. The target analog image signal with the timing difference corrected is described in detail below with reference to FIG. 8.

In operation 640, the analog image signal reception apparatus 200 may receive, from the target analog image signal transmission apparatus, the target analog image signal with the timing difference corrected. The plurality of analog image signals including the target analog image signal with the timing difference corrected, which is received by the analog image signal reception apparatus 200, may be resynchronized signals.

FIG. 7 illustrates a timing difference between a plurality of analog image signals, according to an embodiment.

According to an embodiment, the analog image signal reception apparatus 200 may determine the start time point of a horizontal sync of a first analog image signal 710 to be a reference time point 711, based on first synchronization information of the first analog image signal 710 received from a first analog image signal transmission apparatus. The analog image signal reception apparatus 200 may determine the start time point of a horizontal sync of a second analog image signal 720 to be a first target time point 721, based on second synchronization information of the second analog image signal 720 received from a second analog image signal transmission apparatus. The analog image signal reception apparatus 200 may determine the start time point of a horizontal sync of a third analog image signal 730 to be a second target time point 731, based on third synchronization information of the third analog image signal 730 received from a third analog image signal transmission apparatus.

According to an embodiment, the analog image signal reception apparatus 200 may determine the difference between the reference time point 711 and the first target time point 721 to be a first timing difference 725 of the second analog image signal 720. For example, the first timing difference 725 may be −a. The analog image signal reception apparatus 200 may transmit information about the first timing difference 725 to the second analog image signal transmission apparatus. The second analog image signal transmission apparatus may generate an analog image signal in which the length of the analog image signal is adjusted, based on the information about the first timing difference 725, and transmit the generated analog image signal to the analog image signal reception apparatus 200.

According to an embodiment, the analog image signal reception apparatus 200 may determine the difference between the reference time point 711 and the second target time point 731 to be a second timing difference 735 of the third analog image signal 730. For example, the second timing difference 735 may be +b. The analog image signal reception apparatus 200 may transmit information about the second timing difference 735 to the third analog image signal transmission apparatus. The third analog image signal transmission apparatus may generate an analog image signal in which the length of the analog image signal is adjusted, based on the information about the second timing difference 735, and may transmit the generated analog image signal to the analog image signal reception apparatus 200.

FIG. 8 illustrates target analog image signals in which the length of an analog image signal is corrected, according to an embodiment.

According to an embodiment, after information about a timing difference is transmitted to a target analog image signal transmission apparatus, the analog image signal reception apparatus 200 may receive, from the target analog image signal transmission apparatus, a target analog image signal in which the length of an analog image signal is adjusted. For example, the target analog image signal with the timing difference corrected may include a plurality of horizontal lines including a target horizontal line in which the length of the target horizontal line is corrected to correspond to the timing difference. For example, the target horizontal line may be a first active line.

For example, the analog image signal reception apparatus 200 may not transmit the information about the timing difference or may transmit the timing difference of 0 to a first analog image signal transmission apparatus that transmits an analog image signal for a reference time point. The first analog image signal transmission apparatus may generate an analog image signal 810 in which the length of an analog image signal is not adjusted and may transmit the analog image signal 810 to the analog image signal reception apparatus 200. A previous analog image signal of the analog image signal 810 may correspond to a first frame, and the analog image signal 810 may correspond to a second frame that is a frame following the first frame. The analog image signal 810 may start from a first time point 811. The length of a preset target line 812 of the analog image signal 810 and the length of a target line of the previous analog image signal corresponding to the target line 812 may be the same. For example, the target line 812 may be a first active line.

For example, the analog image signal reception apparatus 200 may transmit information about the timing difference of −a to a second analog image signal transmission apparatus. The second analog image signal transmission apparatus may generate an analog image signal 820 in which the length of an analog image signal is adjusted and may transmit the analog image signal 820 to the analog image signal reception apparatus 200. A previous analog image signal of the analog image signal 820 may correspond to a first frame, and the analog image signal 820 may correspond to a second frame that is a frame following the first frame. The analog image signal 820 may start from a second time point 821. The length of a preset target line 822 of the analog image signal 820 may be longer (e.g., by +a) than the length of a target line of the previous analog image signal corresponding to the target line 822.

For example, the analog image signal reception apparatus 200 may transmit information about the timing difference of +b to a third analog image signal transmission apparatus. The third analog image signal transmission apparatus may generate an analog image signal 830 in which the length of an analog image signal is adjusted and may transmit the analog image signal 830 to the analog image signal reception apparatus 200. A previous analog image signal of the analog image signal 830 may correspond to a first frame, and the analog image signal 830 may correspond to a second frame that is a frame following the first frame. The analog image signal 830 may start from a third time point 831. The length of a preset target line 832 of the analog image signal 830 may be shorter (e.g., by −b) than the length of a target line of the previous analog image signal corresponding to the target line 832.

According to the embodiment described above, although the start time points of the plurality of analog image signals 810, 820, and 830 are all different, since the length of the analog image signal 820 is adjusted by +a and the length of the analog image signal 830 is adjusted by −b, the end time points of the plurality of analog image signals 810, 820, and 830 may all be the same. The next plurality of analog image signals of each of the plurality of analog image signals 810, 820, and 830 may all be synchronized.

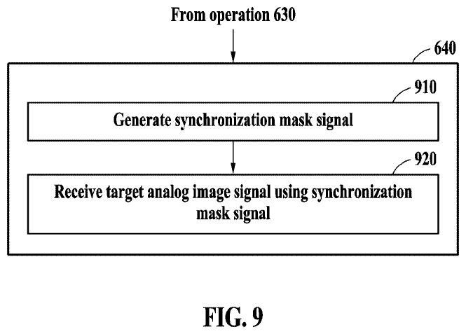

FIG. 9 is a flowchart of a method of receiving a target analog image signal using a synchronization mask signal, according to an embodiment.

As described above with reference to FIG. 8, when the length of an analog image signal is adjusted, an error may occur in a process of recognizing the format of the analog image signal by a line of which the length is adjusted. For example, in an analog image signal transmission/reception system, it may be assumed that the lengths of lines are the same, and accordingly, the format of an analog image is recognized (or determined), but since a line of which the length is temporarily adjusted appears, the format of the analog image may be misrecognized. Operations 910 and 920 below may be performed to compensate for this problem.

According to an embodiment, operation 640 described above with reference to FIG. 6 may include operations 910 and 920.

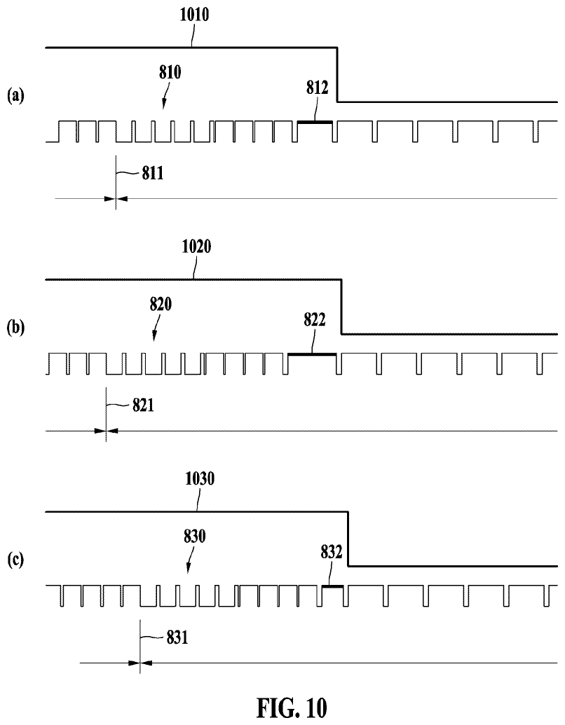

In operation 910, the analog image signal reception apparatus 200 may generate a synchronization mask signal. The synchronization mask signal may be applied to an analog image signal (e.g., the analog image signals 810, 820, and 830 of FIG. 8) of a second frame. The synchronization mask signal is described in detail below with reference to FIG. 10.

The synchronization mask signal may have a high signal in a target area of the synchronization mask signal corresponding to a preset area of a target analog image signal. For example, the high signal section of the synchronization mask signal may be a section set so that the analog image signal reception apparatus 200 does not recognize synchronization information (e.g., a horizontal sync) of a line of an analog image signal corresponding to the high signal section. For example, when a line of which the length is adjusted is a first active line, the synchronization mask signal may be generated so that the high signal section corresponds to one or more lines including the first active line.

According to an embodiment, the length of the high signal section of the synchronization mask signal for the target analog image signal received from a target analog image signal transmission apparatus may be determined based on a timing difference transmitted to the target analog image signal transmission apparatus. For example, when the timing difference of −a is transmitted to the target analog image signal transmission apparatus, the length of the high signal section of the synchronization mask signal for the target analog image signal received from the target analog image signal transmission apparatus may be determined to be longer by +a than the basic length.

In operation 920, the analog image signal reception apparatus 200 may receive the target analog image signal from the target analog image signal transmission apparatus, based on the synchronization mask signal.

FIG. 10 illustrates a synchronization mask signal according to an embodiment.

Synchronization masks 1010, 1020, and 1030 may be respectively applied to the plurality of analog image signals 810, 820, and 830 of the embodiments described above with reference to FIG. 8.

A first synchronization mask 1010 may be applied to the analog image signal 810. The high signal section of the analog image signal 810 may include the preset target line 812. The number of lines included in the high signal section may vary depending on the implementation example.

A second synchronization mask 1020 may be applied to the analog image signal 820. The high signal section of the analog image signal 820 may include the preset target line 822. When the length of the target line 822 becomes longer than the basic length, the length of the high signal section may be lengthened to correspond thereto.

A third synchronization mask 1030 may be applied to the analog image signal 830. The high signal section of the analog image signal 830 may include the preset target line 832. When the length of the target line 832 becomes shorter than the basic length, the length of the high signal section may be shortened to correspond thereto.

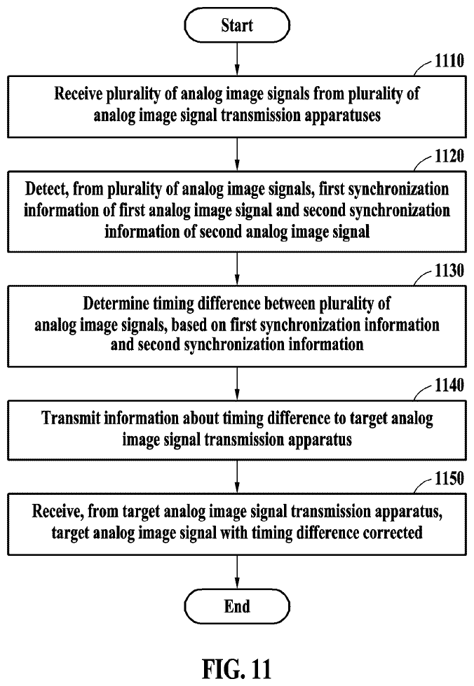

FIG. 11 is a flowchart of a method of receiving a target analog image signal in which the length of an analog image signal is corrected, based on a timing difference between a plurality of analog image signals, according to an embodiment.

Operations 1110 to 1150 below are performed by the analog image signal reception apparatus 200 described above with reference to FIG. 2.

In operation 1110, the analog image signal reception apparatus 200 may receive a plurality of analog image signals from a plurality of analog image signal transmission apparatuses. The description of operation 1110 may be replaced with the description of operation 350 described above with reference to FIG. 3.

In operation 1120, the analog image signal reception apparatus 200 may detect, from the plurality of analog image signals, first synchronization information of a first analog image signal and second synchronization information of a second analog image signal. The description of operation 1120 may be replaced with the description of operation 610 described above with reference to FIG. 6.

In operation 1130, the analog image signal reception apparatus 200 may determine the timing difference between the plurality of analog image signals, based on the first synchronization information and the second synchronization information. The description of operation 1130 may be replaced with the description of operation 620 described above with reference to FIG. 6.

In operation 1140, the analog image signal reception apparatus 200 may transmit, among the plurality of analog image signal transmission apparatuses, information about the timing difference to a target analog image signal transmission apparatus, based on the timing difference. The description of operation 1140 may be replaced with the description of operation 630 described above with reference to FIG. 6.

In operation 1150, the analog image signal reception apparatus 200 may receive, from the target analog image signal transmission apparatus, a target analog image signal with the timing difference corrected. The description of operation 1150 may be replaced with the description of operation 640 described above with reference to FIG. 6.

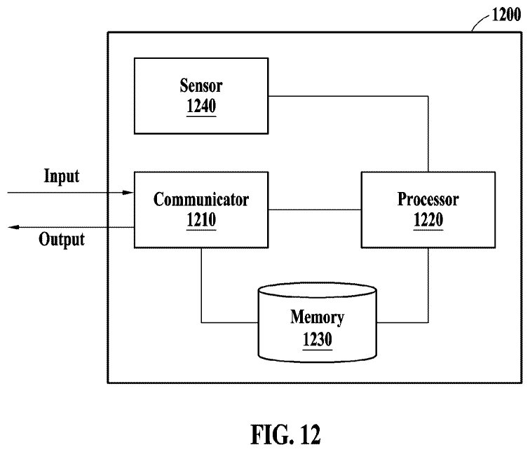

FIG. 12 is a configuration of an analog image signal transmission apparatus, according to an embodiment.

According to an embodiment, an analog image signal transmission apparatus 1200 may include a communicator 1210, a processor 1220, a memory 1230, and a sensor 1240. For example, the analog image signal transmission apparatus 1200 may be the first analog image signal transmission apparatus 120 or the second analog image signal transmission apparatus 130 described above with reference to FIG. 1.

The communicator 1210 may be connected to the processor 1220 and the memory 1230 and transmit and receive data to and from the processor 1220 and the memory 1230. The communicator 1210 may be connected to another external device and transmit and receive data to and from the external device.

The communicator 1210 may be implemented as circuitry in the analog image signal transmission apparatus 1200. For example, the communicator 1210 may include an internal bus and an external bus. In another example, the communicator 1210 may be an element that connects the analog image signal transmission apparatus 1200 to the external device. The communicator 1210 may be an interface. The communicator 1210 may receive data from the external device and transmit the data to the processor 1220 and the memory 1230.

The processor 1220 may process the data received by the communicator 1210 and data stored in the memory 1230. The processor 1220 may execute computer-readable code (e.g., software) stored in a memory (e.g., the memory 1230) and instructions triggered by the processor 1220.

The memory 1230 may store data received by the communicator 1210 and data processed by the processor 1220. For example, the memory 1230 may store a program (or an application or software). The stored program may be a set of syntaxes that are coded to transmit an analog image signal and executable by the processor 1220.

According to an aspect, the memory 1230 may include at least one volatile memory, non-volatile memory, RAM, flash memory, a hard disk drive, and an optical disc drive.

The memory 1230 may store an instruction set (e.g., software) for operating the analog image signal transmission apparatus 1200. The instruction set for operating the analog image signal transmission apparatus 1200 may be executed by the processor 1220.

The sensor 1240 may generate an image by capturing a scene. For example, the sensor 1240 may include a camera. The sensor 1240 may generate an image based on information about the image resolution received from the analog image signal reception apparatus 200. For example, the image may be a digital image.

The processor 1220 may generate an analog image signal based on the digital image.

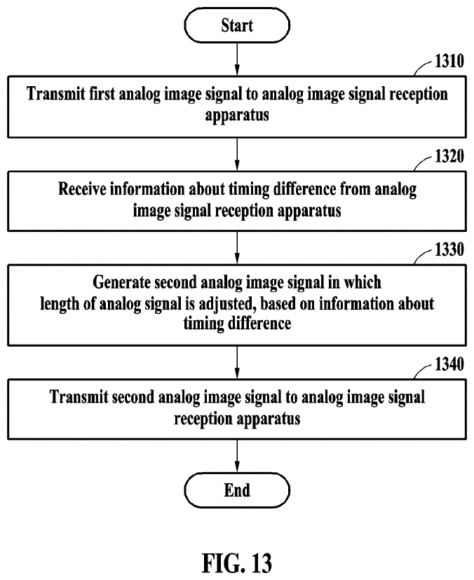

The communicator 1210, the processor 1220, the memory 1230, and the sensor 1240 are described in detail below with reference to FIG. 13.

FIG. 13 is a flowchart of an analog image signal transmission method, according to an embodiment.

Operations 1310 to 1340 below are performed by the analog image signal transmission apparatus 1200 described above with reference to FIG. 12.

In operation 1310, the analog image signal transmission apparatus 1200 may transmit a first analog image signal to an analog image signal reception apparatus. The first analog image signal may correspond to a first frame.

According to an embodiment, when a transmission command signal is received from the analog image signal reception apparatus 200, the analog image signal transmission apparatus 1200 may transmit the first analog image signal to the analog image signal reception apparatus 200.

In operation 1320, the analog image signal transmission apparatus 1200 may receive information about a timing difference from the analog image signal reception apparatus 200. For example, the information about the timing difference may appear in a preset area of the first analog image signal.

In operation 1330, the analog image signal transmission apparatus 1200 may generate a second analog image signal in which the length of an analog signal is adjusted, based on the information about the timing difference. The second analog image signal may correspond to a second frame.

In operation 1340, the analog image signal transmission apparatus 1200 may transmit the second analog image signal to the analog image signal reception apparatus 200.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware apparatus that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The apparatus described above may be configured to act as one or more software modules in order to perform the operations of the embodiments, or vice versa.

The software may include a computer program, a piece of code, an instruction, or some combination thereof, to independently or uniformly instruct or configure the processing apparatus to operate as desired. Software and data may be embodied permanently or temporarily in any type of machine, component, physical or virtual equipment, computer storage medium or apparatus, or in a propagated signal wave capable of providing instructions or data to or being interpreted by the processing apparatus. The software also may be distributed over network-coupled computer systems so that the software is stored and executed in a distributed fashion. The software and data may be stored by one or more non-transitory computer readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, apparatus, or circuit are combined in a different manner, or replaced or supplemented by other components or their equivalents.

Therefore, other implementations, other embodiments, and equivalents to the claims are also within the scope of the following claims.

What is claimed is:

1. An analog image signal reception method performed by an analog image signal reception apparatus, the analog image signal reception method comprising:
generating a camera signal comprising camera operation cycle information;
transmitting the camera signal to a plurality of analog image signal transmission apparatuses;
determining whether each of the plurality of analog image signal transmission apparatuses is ready to transmit an analog image signal;
simultaneously transmitting a transmission command signal to the plurality of analog image signal transmission apparatuses when it is determined that each of the plurality of analog image signal transmission apparatuses is ready to transmit an analog image signal; and
receiving a plurality of analog image signals from the plurality of analog image signal transmission apparatuses.

2. (canceled)

3. The analog image signal reception method of claim 1, wherein the camera signal is added to a horizontal blank area, a horizontal sync area, a front burst interval area, a burst area, or a back burst interval area of an analog image signal.

4. The analog image signal reception method of claim 1, wherein the camera signal is added to a preset area of a line of a vertical blank period of an analog image signal.

5. The analog image signal reception method of claim 1, further comprising:
detecting, from the plurality of analog image signals, first synchronization information of a first analog image signal and second synchronization information of a second analog image signal;
determining a timing difference between the plurality of analog image signals, based on the first synchronization information and the second synchronization information; and
transmitting, among the plurality of analog image signal transmission apparatuses, information about the timing difference to a target analog image signal transmission apparatus, based on the timing difference.

6. The analog image signal reception method of claim 5, further comprising:
receiving a target analog image signal with the timing difference corrected from the target analog image signal transmission apparatus.

7. The analog image signal reception method of claim 6, wherein the target analog image signal with the timing difference corrected comprises a plurality of horizontal lines comprising a target horizontal line in which a length of the target horizontal line is corrected to correspond to the timing difference.

8. The analog image signal reception method of claim 7, wherein the receiving of the target analog image signal with the timing difference corrected from the target analog image signal transmission apparatus comprises:
generating a synchronization mask signal; and
receiving the target analog image signal using the synchronization mask signal.

9. The analog image signal reception method of claim 8, wherein the synchronization mask signal has a high signal in a target area of the synchronization mask signal corresponding to a preset area of the target analog image signal.

10. The analog image signal reception method of claim 9, wherein the preset area of the target analog image signal comprises a vertical blank period, a horizontal blank area, a horizontal sync area, a front burst interval area, a burst area, or a back burst interval area.

11. An analog image signal reception method performed by an analog image signal reception apparatus, the analog image signal reception method comprising:
receiving a plurality of analog image signals from a plurality of analog image signal transmission apparatuses;
detecting, from the plurality of analog image signals, first synchronization information of a first analog image signal and second synchronization information of a second analog image signal;
determining a timing difference between the plurality of analog image signals, based on the first synchronization information and the second synchronization information;
transmitting, among the plurality of analog image signal transmission apparatuses, information about the timing difference to a target analog image signal transmission apparatus, based on the timing difference; and
receiving a target analog image signal with the timing difference corrected from the target analog image signal transmission apparatus.

12. A computer-readable storage medium storing a program for performing the analog image signal reception method of claim 1.

13. An analog image signal reception apparatus for performing an analog image signal reception method, the analog image signal reception apparatus comprising:
a memory configured to store a program for receiving an analog image signal; and
a processor configured to perform the program,
wherein the program is configured to perform:
generating a camera signal comprising camera operation cycle information;
transmitting the camera signal to a plurality of analog image signal transmission apparatuses;
determining whether each of the plurality of analog image signal transmission apparatuses is ready to transmit an analog image signal;
simultaneously transmitting a transmission command signal to the plurality of analog image signal transmission apparatuses when it is determined that each of the plurality of analog image signal transmission apparatuses is ready to transmit an analog image signal; and
receiving a plurality of analog image signals from the plurality of analog image signal transmission apparatuses.

14. An analog image signal transmission method performed by an analog image signal transmission apparatus, the analog image signal transmission method comprising:
transmitting a first analog image signal to an analog image signal reception apparatus;
receiving information about a timing difference from the analog image signal reception apparatus;
generating a second analog image signal in which a length of an analog image signal is adjusted, based on the information about the timing difference; and
transmitting the second analog image signal to the analog image signal reception apparatus.

15. An analog image signal transmission apparatus for performing an analog image signal transmission method, the analog image signal transmission apparatus comprising:
a memory configured to store a program for transmitting an analog image signal; and
a processor configured to perform the program,
wherein the program is configured to perform:
transmitting a first analog image signal to an analog image signal reception apparatus;
receiving information about a timing difference from the analog image signal reception apparatus;
generating a second analog image signal in which a length of an analog image signal is adjusted, based on the information about the timing difference; and
transmitting the second analog image signal to the analog image signal reception apparatus.
